(19) United States
(12) Patent Application Publication
(10) Pub. No.: US 2017/0193644 A1
(43) Pub. Date: Jul. 6, 2017

(54) BACKGROUND REMOVAL

(71) Applicant: eBay Inc., San Jose, CA (US)

(72) Inventor: Chall Fry, Portland, OR (US)

(21) Appl. No.: 14/985,108

(22) Filed: Dec. 30, 2015

(51) Int. Cl. G06T 5/40; G06T 7/40

(52) U.S. Cl. CPC G06T 5/40; G06T 7/408

(57) ABSTRACT

A method of displaying a portion of a captured scene may include visually capturing a scene at a mobile device. An area of the captured scene associated with a foreground object of the captured scene may be identified at the mobile device. The mobile device may display, in real time, a displayed scene including a foreground portion of the captured image associated with the area identified as being associated with the foreground object of the captured scene. The displayed scene may further include a background different from a background portion of the captured image not associated with the area identified as being associated with the foreground object of the captured scene. The displayed scene may demonstrate an expected result of a separate background removal process.

### FIELD

Some embodiments described herein generally relate to background removal.

### BACKGROUND

Unless otherwise indicated herein, the materials described herein are not prior art to the claims in the present application and are not admitted to be prior art by inclusion in this section.

Background removal may generally be performed on an image to remove or otherwise hide a portion of the image associated with a background. The remaining or otherwise unhidden portion of the image may be associated with a foreground object. In some instances, background removal may be performed on images of products to be offered for sale via a marketplace.

The subject matter claimed herein is not limited to embodiments that solve any disadvantages or that operate only in environments such as those described above. Rather, this background is only provided to illustrate one technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to background removal.

In an example embodiment, a method of displaying a portion of a captured scene may include visually capturing a scene at a mobile device. An area of the captured scene associated with a foreground object of the captured scene may be identified at the mobile device. The mobile device may display, in real time, a displayed scene including a foreground portion of the captured image associated with the area identified as being associated with the foreground object of the captured scene. The displayed scene may further include a background different from a background portion of the captured image not associated with the area identified as being associated with the foreground object of the captured scene. The displayed scene may demonstrate an expected result of a separate background removal process.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a diagrammatic representation of a background removal system;

FIG. 2 is a flowchart of an example method of background removal;

FIG. 3 illustrates a simplified example captured scene;

FIG. 4 illustrates a simplified example histogram in CIELAB color space;

FIG. 5 illustrates a simplified example pixel map;

FIG. 6 illustrates a simplified example edge map;

FIG. 7 illustrates a simplified example foreground edge map;

FIG. 8 illustrates a simplified example foreground area map;

FIG. 9 illustrates a simplified example display; and

FIG. 10 is a flowchart of another example method of background removal.

### DESCRIPTION

In some instances, an online marketplace may employ a background removal system for removing background image data from an image of an object a seller wishes to offer for sale via the online marketplace. The background removal system may include a server that receives a raw image from the seller and performs background removal via various background removal techniques at the server to produce a processed image. The processed image may then be approved or rejected by the seller and/or used in association with a listing on the online marketplace.

In some instances, the seller may take a picture of the object for sale with the object for sale in the foreground of the picture. In some instances, the seller may use a mobile device such as a mobile phone or tablet computer to take the picture. The seller may then send a raw image of the object to the server to perform a background removal process on the raw image. The raw image may include a foreground image of the object and a background image. In some configurations, the background removal server may attempt to identify the image data associated with the foreground image of the object in the raw image and remove other image data from the raw image to generate a processed image that includes the image data that the background removal server identified as associated with the foreground object.

In some situations, the processed image may be undesirable to the seller, the online marketplace, and/or a potential buyer in some way. For example, the background removal server may incorrectly identify portions of the background image as associated with the foreground image of the object, and/or may incorrectly identify portions of the foreground image of the object as associated with the background. As a result, the processed image may include portions of the background and/or may omit portions of the item to be sold (e.g., the foreground image of the object). The unsuccessful background removal may be a result of a number of issues with the raw image, such as the background including colors similar to colors included in the foreground object, shadows across the foreground object and/or the background, general lighting conditions, background features that may be identified as being associated with the foreground object, or the like.

In an attempt to reduce the number of undesirable images used in listings on the online marketplace, the background removal server may send the processed image or some representation of the processed image back to the seller for approval before the processed image is used in association with the seller's listing. The seller may review the processed image, and, if the processed image is acceptable, may approve the image for use in the online marketplace. If the processed image is not acceptable, the seller may take another picture of the object with changed conditions in an attempt to correct the issues experienced by the background removal server and result in an acceptable image.

However, in many instances the seller may experience a delay between taking the picture and receiving the processed image for review. The delay may be influenced by a number of factors, including the length of time taken to transmit the image data from the seller's mobile device to the background removal server, the length of time taken to produce the processed image at the background removal server, the length of time taken to transmit the processed image from the background removal server to the seller's mobile device, and the like. The delay experienced by the seller may frustrate the seller, particularly in situations where it takes the seller several attempts to capture a raw image that results in a suitable processed image.

Frustrated sellers may underutilize the background removal server. For example, frustrated sellers may opt to approve a processed image with noticeable errors rather than invest time to take another picture. Alternately, frustrated sellers may avoid using the background removal server altogether, instead opting to use raw images with the background remaining and/or images of a similar object in place of an image of the actual object being offered for sale.

If the background removal server is underutilized, the online marketplace and/or the sellers may not fully experience the advantages that may be available through use of the background removal server.

Furthermore, processing resources, bandwidth resources, and other resources may be used in unsuccessful background removal attempts. Thus, for example, unsuccessful background removal attempts by background removal servers may tie up processing or bandwidth resources unnecessarily, potentially leading to losses in network throughput and/or a background removal server's utilized output.

Some embodiments may encourage background removal utilization and/or efficient utilization of background removal resources. Some embodiments may leverage users' existing skills and routines, e.g., positioning a mobile device to take a picture and using immediate feedback from a camera preview to compose the shot, for a background removal process. For example, with a background removal feature enabled, the user may selectively position their mobile device and review the camera preview to compose a shot that facilitates satisfactory background removal. The background removal may be performed by the mobile device in substantially real time. For example, lag times between capturing an image and displaying the image with the background removal processes performed on the camera preview may be less than 100 milliseconds (ms). Alternately, the lag may be 100 ms or more. Thus, some embodiments may integrate background removal into the picture composition process.

Performing background removal at the mobile device may result in sacrifices in the background removal processes relative to those performed at a server or other non-mobile computer. Put another way, relative to the cutting-edge background removal algorithms that may be implemented on high-performance servers, some embodiments may utilize a merely-acceptable background removal process that may be performed with a relatively minor lag on a mobile device. Regardless of the sacrifices in the background removal processes, integrating the background removal into the picture composition activity may produce better results in a shorter amount of time relative to post-processing background removal.

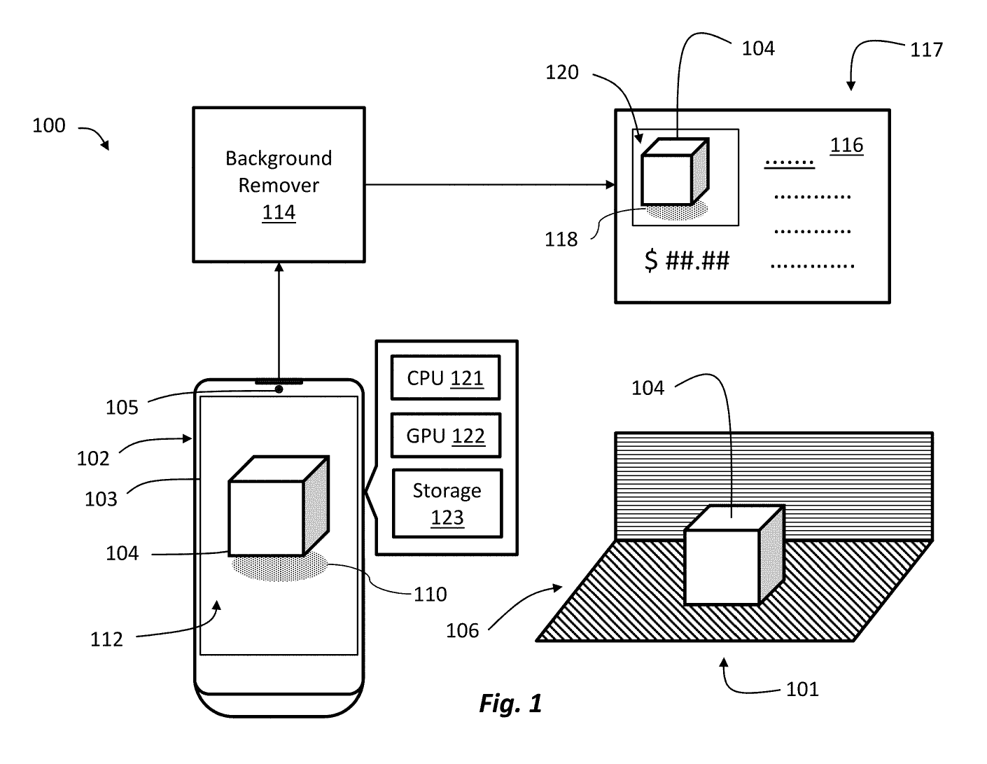

FIG. 1 is a diagrammatic representation of a background removal system 100. The system 100 may reduce the problems experienced by other background removal systems. For example, the system 100 may allow sellers or other users to identify images that a background remover 114 may successfully process before sending any images to the background remover 114. As a result, a seller may produce a suitable processed image 120 for use in a listing 116 of an online marketplace 117 without enduring the delay associated with sending multiple raw images to the background remover 114 and reviewing multiple potential processed images. Advantageously, the system 100 may be less frustrating for a seller to use, and may lead to relatively wider adoption of background removal, potentially benefitting the seller and/or the online marketplace 117.

The system 100 may include a mobile device 102. The system 100 may be used to provide a seller or other user with visual feedback via the mobile device 102 regarding a likelihood that a background remover 114 will successfully remove background image data from a raw image of a particular scene 101 before the image is sent to the background remover 114.

In some embodiments, the system 100 may be used by sellers who use the online marketplace 117 to sell goods. The system 100 may allow the sellers to save time and/or data transmission resources in the process of offering an item for sale on the online marketplace 117 via a listing 116. Alternately or additionally, the system 100 may improve the quality of the images used in the listing 116, which may increase seller satisfaction with the online marketplace 117, buyer satisfaction with the online marketplace 117, public perception of the online marketplace 117, and/or the like.

The mobile device 102 includes a display 103 and one or more cameras, such as a front-facing camera 105 and/or a rear-facing camera. The camera of the mobile device 102 may be used to capture the scene 101 including a foreground object 104 and a background 106. In some lighting conditions, the scene may include a shadow of the foreground object 104. As used herein, capturing the scene 101 includes any way in which the mobile device 102 generates image data of the scene 101 via the camera of the mobile device 102. For example, the mobile device 102 may capture the scene 101 by pointing the camera at the scene 101 with the camera activated. Alternately or additionally, the mobile device 102 may capture the scene 101 by converting the captured scene to image data and storing the image data in a memory of the mobile device 102.

The mobile device 102 may include a central processing unit (CPU) 121, a graphics processing unit (GPU) 122, and a non-transitory storage medium 123 coupled to the CPU 121 and the GPU 122. The storage medium 123 may include instructions stored thereon that, when executed by the CPU 121 and/or the GPU 122, may cause the mobile device 102 to perform the operations, methods, and/or processes described herein.

In some embodiments, the display 103 may function as a viewfinder showing the scene 101 in real-time as an estimation image 112, e.g., in a manner analogous to so-called augmented reality. Alternately or additionally, the mobile device 102 may capture a preliminary image of the scene 101 and may generate the estimation image 112 based on the preliminary image. Alternately or additionally, the mobile device 102 may generate the estimation image 112 based on image data that the seller has captured to potentially send to the background remover 114 as a raw image.

The estimation image 112 may approximately reflect the success or likelihood that the background remover 114 would have in removing the background 106 from the scene 101 and leaving the foreground object 104 in the scene 101 under various conditions. For example, the mobile device 102 may perform a subset of background-removal algorithms that the background remover 114 uses to remove the background from a raw image to create the processed image 120. Thus, the estimation image 112 may provide feedback regarding whether the conditions of the scene 101 are conducive to background removal by the background remover 114. For example, if the background remover 114 would fail to remove a portion of the background 106 and/or would remove a portion of the foreground object 104, the estimation image 112 may include the same errors.

In some instances, the system 100 may allow a user, while directing the camera of the mobile device 102 towards the scene 101, to move the mobile device 102 to different locations and/or orientations, to change lighting conditions of the scene 101, and/or the like to find a set of conditions satisfactorily conducive to background removal by the background remover 114.

In some embodiments, the background removal algorithms performed by the mobile device 102 may be computationally less demanding than the background removal algorithms of the background remover 114. As a result, the background removal algorithms performed by the mobile device 102 may be suitably performed with a processing budget available from the mobile device 102. For example, the background removal algorithms performed by the mobile device 102 may include approximations of the background removal algorithms performed by the background remover 114. Alternately or additionally, the background removal algorithms performed by the mobile device 102 may include fewer computational cycles than the background removal algorithms of the background remover 114. In some embodiments, the image quality of the estimation image 112 may be reduced to facilitate background removal at a suitable rate using the processing resources available from the mobile device 102. However, the quality of the raw image sent to the background remover 114 may not be reduced. In some embodiments, the background removal algorithms performed by the mobile device 102 may be suboptimal relative to the background removal algorithms of the background remover 114.

In some embodiments, the background remover 114 may insert a catalog shadow 118 into the processed image 120. The catalog shadow 118 may improve the appearance of the listing 116, the foreground object 104 and/or the processed image 120 for potential buyers. Optionally, the mobile device 102 may include an estimated shadow 110 in the estimation image 112. Analogously to the background removal described herein, the estimated shadow 110 may reflect an approximation of the success the background remover 114 may have in adding the catalog shadow 118.

In some embodiments, the mobile device 102 may offer tips for preparing the scene 101 in a way that improves the likelihood of successful background removal. For example, the mobile device 102 may offer alternate background colors and/or background types, alternate lighting conditions, alternate camera angles, or the like or any combination thereof. In some instances, the tips may be specific to the appearance, color, and/or shape of the foreground object 104.

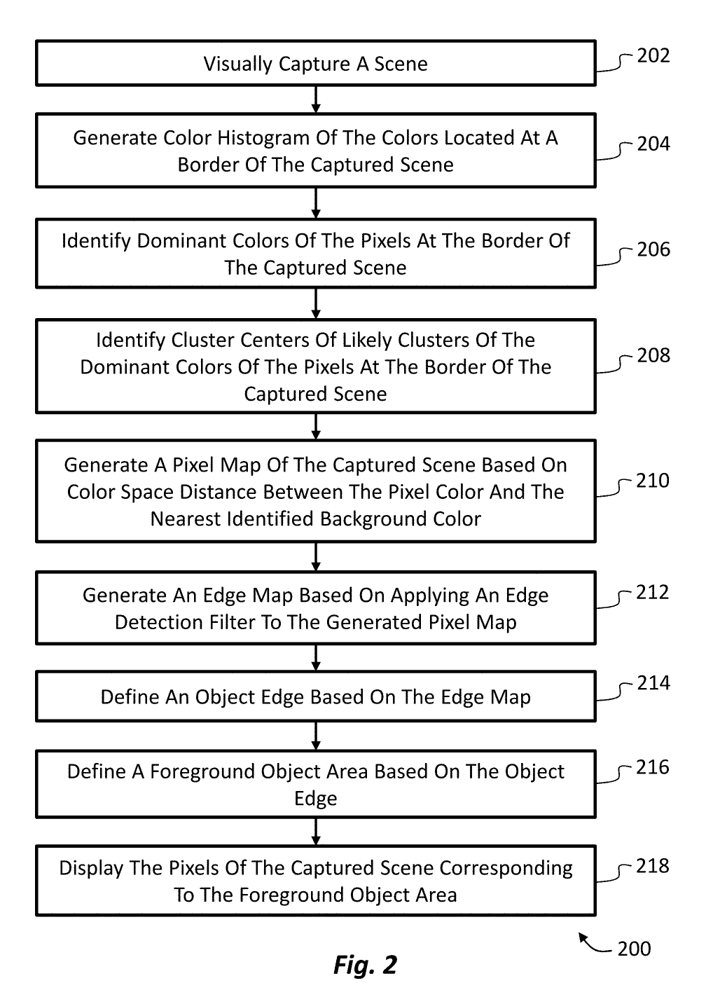

FIG. 2 is a flowchart of an example method 200 of background removal. In some embodiments, the method 200 may be performed by a mobile device, such as the mobile device 102 of FIG. 1.

The method 200 may begin at block 202 by visually capturing a scene. The scene may include a foreground, such as an object or objects a user intends to offer for sale via an online marketplace. Additionally, the scene may include a background, such as an environment in which the foreground object or objects are located. By way of example, the scene, the foreground object, and the background may correspond, respectively, with the scene 101, the foreground object 104, and the background 106 of FIG. 1. Visually capturing the scene may include pointing a camera at the scene with the camera activated. For example, capturing the scene may include pointing the active camera at the scene in a manner similar to that of preparing to take a photo. Alternately or additionally, visually capturing the scene may include storing image data representing the scene at the mobile device.

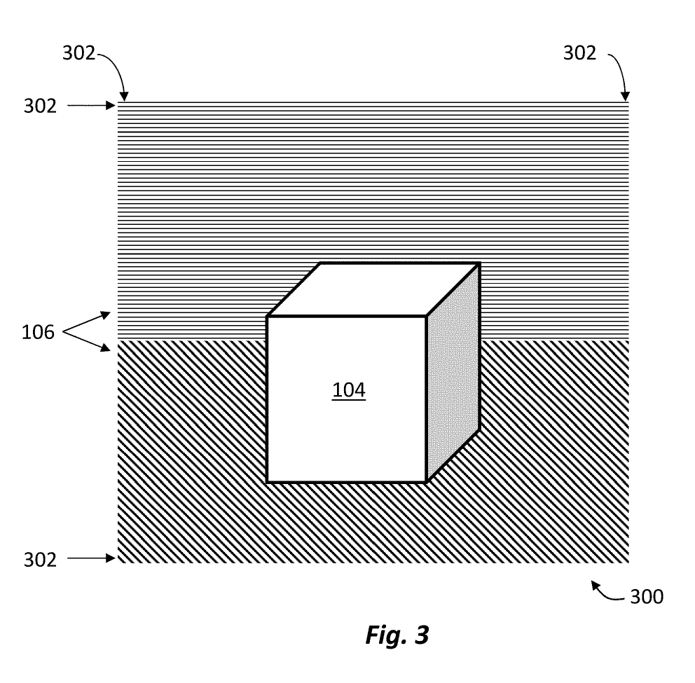

FIG. 3 illustrates a simplified example captured scene 300, which may generally correspond to the captured scene of block 202 of the method 200 of FIG. 2. The captured scene 300 may include a border area 302 made up of one or more rows of pixels. A user capturing the scene 300 may generally attempt to capture the scene with the foreground object 104 away from the border area 302 of the captured scene 300 in order to ensure that the entire foreground object 104 is captured within the scene. Thus, for example, the pixels in the border area 302 may be associated with the background 106.

With reference to FIG. 2, the method 200 may continue at block 204 by generating a color histogram of the colors at a border of the captured scene. The border of the captured scene may generally correspond to colors of the border area 302 of the captured scene 300 of FIG. 3. In some embodiments, part or all of block 204 may be performed by a graphics processing unit (GPU), such as the GPU 122 of FIG. 1, or by another single instruction, multiple data (SIMD) processor.

The color histogram may be generated for one or more lines (e.g., rows and/or columns) of pixels located along or relatively close to the outermost edges of the captured scene. The border of the captured scene may be relatively unlikely to include a portion of the foreground object, and thus may include colors primarily associated with the background. The number of border pixels considered in generating the color histogram may be on the order of approximately 100,000 pixels. In some embodiments, the number of border pixels considered may be more than 100,000 or less than 100,000.

In some embodiments, the color histogram may be generated in CIE L*a*b* (CIELAB) color space. Thus, for example, the pixels to be used for the color histogram may be converted to CIELAB color space if the pixels are associated with a different color space, such as a red, green, and blue (RGB) color model.

In some embodiments, the color histogram may include a three-dimensional array of buckets. For example, the color histogram may include an array of buckets in a lightness (L*) dimension, a green-magenta (a*) dimension, and a blue-yellow (b*) dimension. For example, the color histogram may include a 3×32×32 array of buckets having 32×32 arrays in the a* and b* dimensions associated with three ranges of bucket values for L*. Thus, for example, a 32×32 array of buckets (e.g., each bucket may span a 6.25×6.25 range in the a* and b* dimensions) may be associated with each of a low range of L* (such as 0≦L*<33), a middle range of L* (such as 33≦L*<66), and a high range of L* (such as 66≦L*<100). Alternately, different sizes of buckets, different numbers of buckets, and/or different ranges of buckets may be used.

By way of example, the color of each of the border pixels considered may fall into one of 3072 buckets. Thus, for example, where a 3×32×32 array is used, the color histogram may provide a count of pixels having one of 3072 approximate colors.

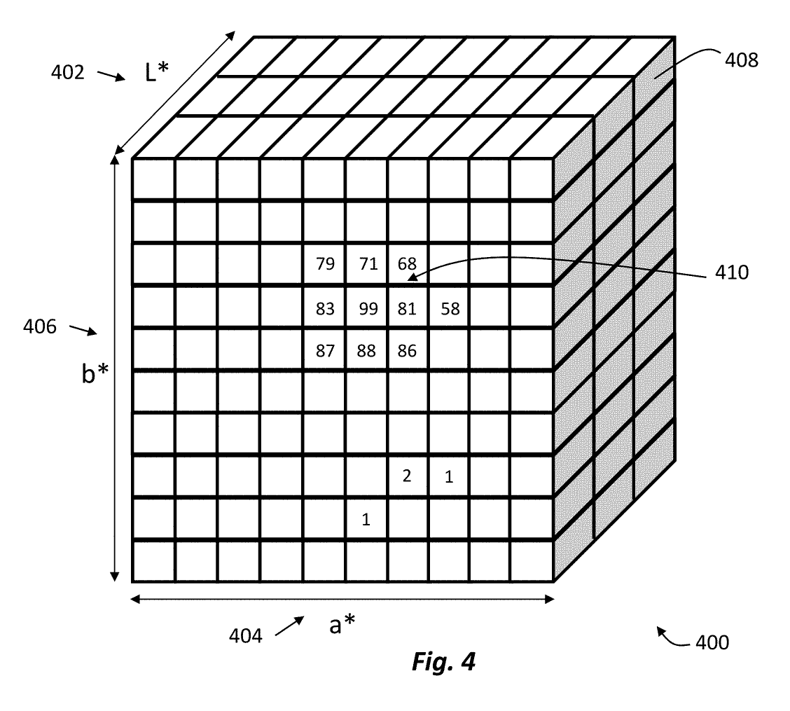

FIG. 4 illustrates a simplified example histogram 400 in CIELAB color space, which may generally correspond to the histogram of block 204 of FIG. 2. The histogram 400 may include the L* 402, a* 404, and b* 406 color space divided into a 3×10×10 array of buckets 408. Although a 3×10×10 array is shown for clarity, the color space of the histogram 400 may analogously be divided into smaller buckets 408, each covering a relatively smaller portion of the color space. For example, the histogram 400 may include a 3×32×32 array of buckets 408 or some other sized array of buckets. The example bucket values 410 may represent counts of pixels having a color located within the color space associated with the respective bucket 408.

With reference to FIG. 2, the method 200 may continue to block 206 by identifying dominant colors of the considered border pixels. In some embodiments, part or all of block 206 may be performed by a GPU, such as the GPU 122 of FIG. 1, by another single instruction, multiple data (SIMD) processor, by a CPU, such as the CPU 121 of FIG. 1, or another processor. For example, where block 204 is performed by the GPU, block 206 may be performed by the GPU to promote pipelining of the operations. For this and other blocks, transitioning from GPU work to CPU work may be relatively costly in terms of time and/or processing resources, as the CPU may be instructed to wait for the GPU to finish its tasks before the CPU tasks are started. In some embodiments, the number of transitions between GPU work and CPU work may be reduced, particularly where the cost of transitioning may be greater than a cost saving realized by transitioning.

In some embodiments, the largest bucket in the histogram may be identified. Additionally, buckets neighboring the largest bucket that have a value above a threshold value may also be identified. In some embodiments, the identified buckets may be zeroed out or otherwise ignored and the steps of identifying the largest buckets and, potentially, neighboring buckets above a threshold value may be repeated until a threshold number of the considered pixels have been accounted for. For example, the buckets may be identified and zeroed out until 99% of the considered pixels are accounted for.

Thus, for example, background colors may be roughly identified. The roughly identified background colors may include the identified buckets and/or the neighboring buckets above the threshold value.

With reference to FIG. 4, block 206 of the method 200 may, by way of example, identify the bucket associated with a value of 99 and may zero out the bucket's value. Additionally, the buckets associated with values of 88, 87, 86, 83, 81, 79, 71, 68, and 58 may also be zeroed out if a threshold value is equal to or less than 57.

With reference to FIG. 2, the method 200 may continue to block 208 by identifying cluster centers of the roughly identified background colors. In some embodiments, part or all of block 208 may be performed by a CPU, such as the CPU 121 of FIG. 1, or another processor.

In some embodiments, the cluster centers may be identified by performing 3-dimensional cluster analysis. The histogram evaluation of block 206 may identify one or more groups of relatively similar background colors that encompass multiple buckets. Cluster analysis may be used to identify a cluster center of each of the groups of relatively similar background colors. In some embodiments, the cluster centers may be identified via a single iteration of k-means cluster analysis. In identifying the cluster centers, identifying the actual clusters may be unnecessary. Thus, for example, steps for identifying the cluster may be ignored to find a center of a likely cluster.

By way of example, 1-4 cluster centers, which may correspond approximately to the dominant colors in the background of the captured image, may be identified. Alternatively, 5 or more cluster centers may be identified. The number of cluster centers identified may depend, at least in part, on the composition of the captured image. For example, if the captured image includes a single, relatively solid color in the background, one cluster centers may be identified. Alternately, if the captured image includes multiple colors and/or patterns, more than one cluster center may be identified.

The method 200 may continue at block 210 by generating a pixel map. The pixel map may be based in part on the identified cluster centers of block 208. In some embodiments, part or all of block 210 may be performed by a GPU, such as the GPU 122 of FIG. 1, or by another SIMD processor.

A brightness of each pixel of the pixel map may be based on the distance in color space units between the color of the pixel in the captured image and the nearest cluster center. Thus, for example, pixels of the captured image having colors relatively near to an identified cluster center may be relatively near black in the pixel map. Furthermore, for example, pixels of the captured image having colors relatively far from an identified color center may be relatively bright in the pixel map.

Thus, for example, the pixel map may represent a texture associated with “not-background” qualities of different portions of the captured scene. By way of example, where the captured scene includes a single background color, the pixel map may indicate how close, in color space, the color of each pixel is to the background color.

Optionally, block 210 may facilitate some shadow removal. For example, in some embodiments, brightness differences may be ignored when determining distances between the color of the pixels of the captured scene and the cluster center when the color of the pixels have a similar chroma as the cluster center, but are darker than the cluster center. Put another way, for each background color identified, if a pixel of the captured scene has a similar chroma to the background color and is darker than the background color, the pixel may be assumed to be a shadow and the relative darkness of the pixel may be ignored in determining its distance from the background color. Thus, for example, the distance may be at or close to zero, resulting in a black or near-black pixel on the pixel map.

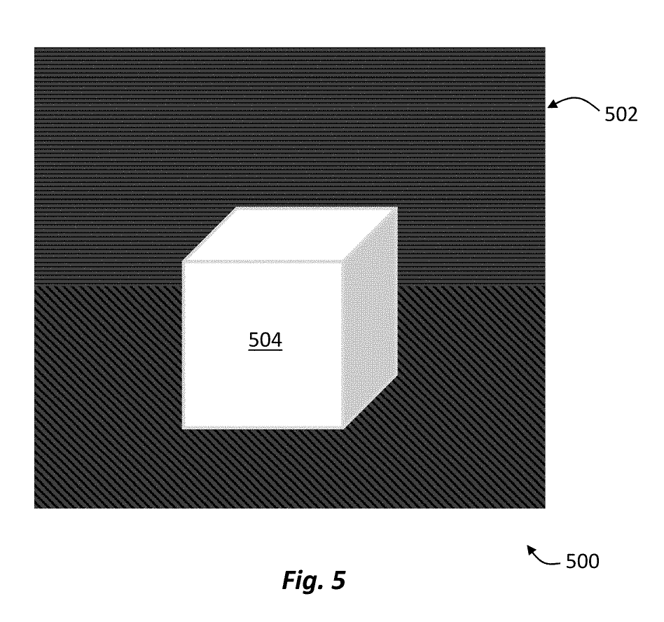

FIG. 5 illustrates a simplified example pixel map 500, which may generally correspond to the pixel map of block 210 of the method 200 of FIG. 2. The pixel map 500 may include a dark area 502 associated with the background 106 of the captured scene 300 of FIG. 3. Additionally, the pixel map 500 may include a light area 504 associated with the foreground object 104 of the captured scene 300 of FIG. 3. The color differences of the features of the dark area 502 may be suppressed relative to the color differences in the background 106 of the captured image 300. Furthermore, the color difference of the features of the light area 504 may also be suppressed relative to the color differences in the foreground object 104 of the captured image 300.

With reference to FIG. 2, the method 200 may continue at block 212 by producing an edge map based on the pixel map. In some embodiments, part or all of block 212 may be performed by a GPU, such as the GPU 122 of FIG. 1, or by another SIMD processor.

The edge map may be produced by performing edge detection on the pixel map produced in block 210. In some embodiments, block 212 may include running a Sobel edge detection filter on the pixel map produced in block 210. The edge map may be biased to highlight transitions between a background color and a non-background color. For example, a transition between two background colors may not manifest brightly, as both background colors may be relatively dark in the pixel map. Thus, for example, edge detection may exhibit a relatively low response. Furthermore, edge detection between different non-background colors may be suppressed, as the pixels may be relatively bright in the pixel map. Edge detection of a transition between a background color and a non-background color may not be suppressed and/or may be enhanced, as the background may be relatively dark and the non-background may be relatively bright.

Optionally, the method 200 may continue to an edge-refining step by performing a convolution operation on the pixel map resulting from block 212 or the edge map resulting from block 214. The convolution operation may calculate a mean and a standard deviation of a pixel kernel, such as a 5×5 pixel kernel, centered on a destination pixel. The mean and the standard deviation may be associated with the destination pixel. For example, the mean and the standard deviation values may be associated with the destination pixel via the red and green color channels of the pixel. Thus, for example, a lone pixel having a color not closely associated with the background color that is surrounded by pixels associated with the background color will be suppressed, as the mean and standard deviation may be relatively low. Employing the standard deviation values may counteract a suppression effect that may otherwise be experienced through the mean values near edges of the foreground object. By way of example, the edge-refining step may result in an image colored red at the interior of the foreground object and is colored green at the outer edge of the foreground object. The edge-refining step may be less susceptible to edge detection failures, particularly when the edges are slightly blurry. In some embodiments, part or all of the edge-refining step may be performed by a GPU, such as the GPU 122 of FIG. 1, or by another SIMD processor.

Optionally, the method 200 may alternately continue to an edge-thinning step by performing edge thinning on the edge map produced in block 212. In some embodiments, part or all of the edge-thinning step may be performed by a GPU, such as the GPU 122 of FIG. 1, or by another SIMD processor.

Edge thinning may include identifying relatively blurry edges and refining the results to produce relatively sharper edges. In some embodiments, edge thinning may include finding an edge that spans multiple pixels and merging the results into the pixel that exhibits the largest response. By way of example, a line of pixels may include the following values associated with edges of the edge map.
0 0 0 1 35 17 5 2 0

Edge thinning may include declaring the highest value, “35” pixel as being associated with a real edge and the edge values for the line of pixels may be adjusted to the following values.
0 0 0 0 60 0 0 0 0

For example, the values of the pixels surrounding the highest value, “35” pixel may be added to the value of the highest value pixel to arrive at a new value of 60 (e.g., 35+17+5+2+1) and zeroed. Alternately, fewer than all of the values of the surrounding pixels may be added to the highest value pixel. For example, the highest value pixel may be increased to 53 (e.g., 1+35+17) and all of the other pixels may be zeroed or only the pixels added to the value of the highest value pixel may be zeroed.

In some embodiments, derivatives of the pixel values may be calculated and used in the edge thinning process. However, computational resource budgets may encourage the use of a more direct edge thinning, such as that described above.

Optionally, the method 200 may alternately or additionally continue to an edge-suppression step by performing spurious edge suppression. In some embodiments, part or all of the edge-suppression step may be performed by a GPU, such as the GPU 122 of FIG. 1, or by another SIMD processor.

Spurious edge suppression may act, in part, to reject edges formed about isolated “bumps” in the pixel map. By way of example, a line of pixels may include the following values associated with edges of the edge map.
0 0 −3 −18 25 1 0 0

The positive values may indicate large numbers to the left in the pixel map, and the negative numbers may indicate large numbers to the right in the pixel map. Put another way, the non-zero values may indicate that the pixel appears to be an edge, with the negative values indicating that a foreground side of the edge appears to be to the right and the positive values indicating that a foreground side of the edge appears to be to the left. In the example line of pixels provided above, there appears to be a 4-pixel-wide object. In practice, such an object is unlikely to belong to the foreground object. Instead, the object may often be a speck of dust, a transition between two significantly differently-colored areas of the background, or some other undesirable artifact. Thus, for example, pixel values above and below the line may be considered to determine whether the edge may be a one-pixel wide line, a corner, or the like, and if the edge appears spurious, e.g., not belonging to a foreground object, the values may be changed to zero and/or the edge may be otherwise suppressed.

The edge-refining step, the edge-thinning step, and/or the edge-suppression step may produce an edge map that describes edges with better fidelity than was subject to the step or steps.

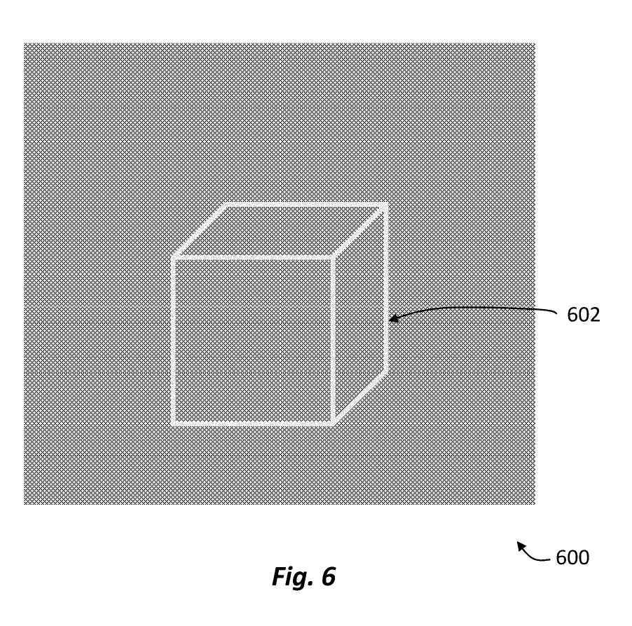

FIG. 6 illustrates a simplified example edge map 600, which may generally correspond to the edge map resulting from block 212, the edge-refining step, the edge-thinning step, or the edge-suppression step, depending on whether one or more of the edge-refining step, the edge-thinning step, and the edge-suppression step were performed. The edge map 600 may include a mapped edge 602. In some embodiments, the edge map 600 may overlay the pixel map 500 and/or may include a composite of the pixel map 500 and the mapped edge 602.

With reference to FIG. 2, in some embodiments, the method 200 may continue to block 214 by defining a foreground edge. In some embodiments, part or all of block 214 may be performed by a CPU, such as the CPU 121 of FIG. 1, or another processor.

The foreground edge may be defined based on the edge map resulting from block 212, the edge-thinning step, or the edge-suppression step, depending on whether one of, neither, or both the edge-thinning step and the edge-suppression step were performed. In some embodiments, the foreground edge may be defined, in part, by considering each line of the edge map, determining the two largest edge response values, and defining them as a right edge and a left edge or a top edge and a bottom edge of the foreground.

In some embodiments, the foreground edge may be defined via a hysteresis filter, which may include a multiple-pixel wind-back feature. Optionally, the hysteresis filter and/or other edge-finding filters may apply threshold values based at least in part on brightness values from block 212. For example, the method 200 may consider the edge brightness values and may generate information regarding the number of pixel brighter than various potential thresholds, which may be used to define upper thresholds, lower thresholds, and/or other thresholds for the foreground edge filters.

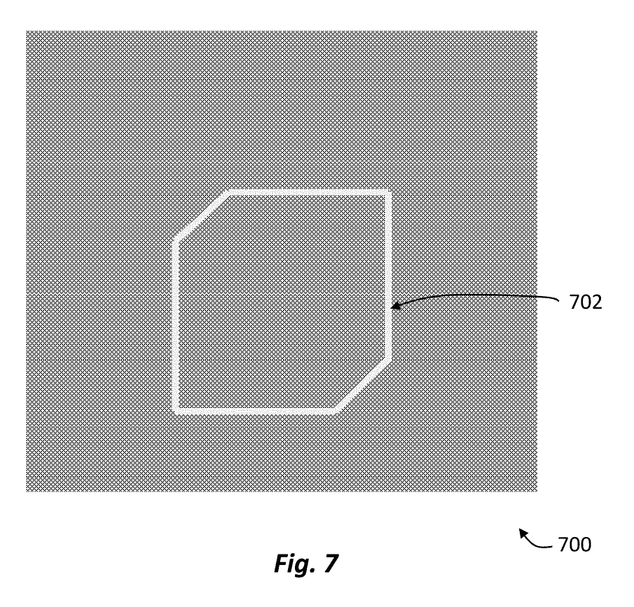

FIG. 7 illustrates an example foreground edge map 700 including a foreground edge 702, which may generally correspond to the foreground edge resulting from block 214. In some embodiments, the foreground edge map 600 may overlay the pixel map 502 and/or the edge map 602. Alternately, the foreground edge map 600 may include a composite of the pixel map 500, the mapped edge 602, and/or the foreground edge 702.

With reference to FIG. 2, in some embodiments, the method 200 may continue to block 216 by defining a foreground object area. The foreground object area may be based on the foreground edge defined in block 214. In some embodiments, part or all of block 216 may be performed by a GPU, such as the GPU 122 of FIG. 1, or by another SIMD processor. The foreground object area may be defined as an area encompassed by the foreground edge defined in block 214.

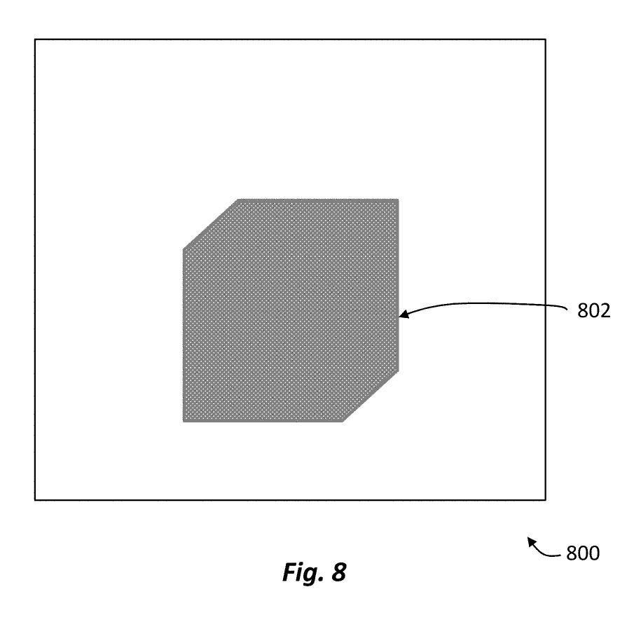

FIG. 8 illustrates a foreground area map 800 including a foreground object area 802, which may correspond to the foreground object area resulting from block 216.

With reference to FIG. 2, in some embodiments, the method 200 may continue to block 218 by displaying the foreground object. In some embodiments, part or all of block 218 may be performed by a GPU, such as the GPU 122 of FIG. 1, and a display, such as the display 103 of FIG. 1.

Displaying the foreground object may be based on the foreground object area defined in block 216. Pixels of the captured scene associated with the foreground object area may be passed through to a display.

In some embodiments, pixels of the captured scene not associated with the foreground object area may not be displayed. For example, the pixels of the captured scene not associated with the foreground object may be displayed as white pixels, or some other color and/or pattern of pixels. Alternately or additionally, the pixels of the captured scene not associated with the foreground object may be replaced with pixels from another image, such as a studio blank image. Studio blank images may include high-quality images of a product background captured without a foreground object.

Optionally, a portion of the pixels not associate with the foreground object may be displayed such that the foreground object appears to include a shape having a color darker than the displayed background positioned below the image of the foreground object, described herein as a catalog shadow. In some embodiments, the catalog shadows may encourage similarly proportioned, shaped, and/or colored shadows between different products offered through an online marketplace or the like.

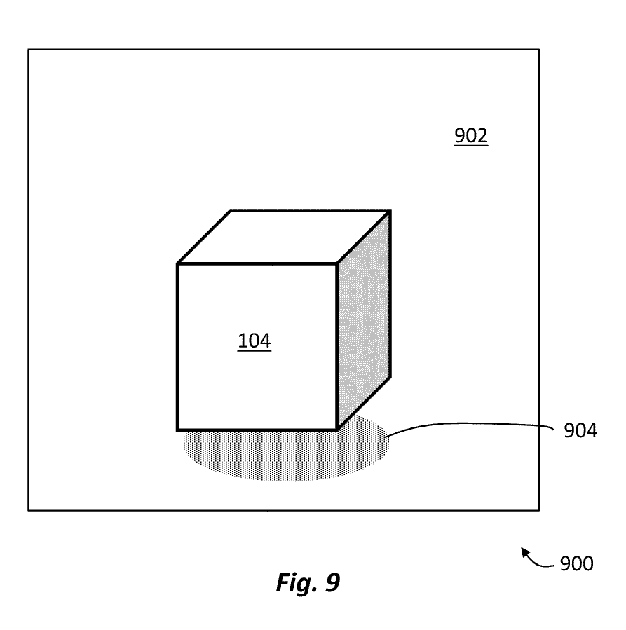

FIG. 9 illustrates an example display 900 of the foreground object 104, a replacement background 902, and a catalog shadow 904, which may correspond to the display resulting from block 218 and the step of adding a catalog shadow.

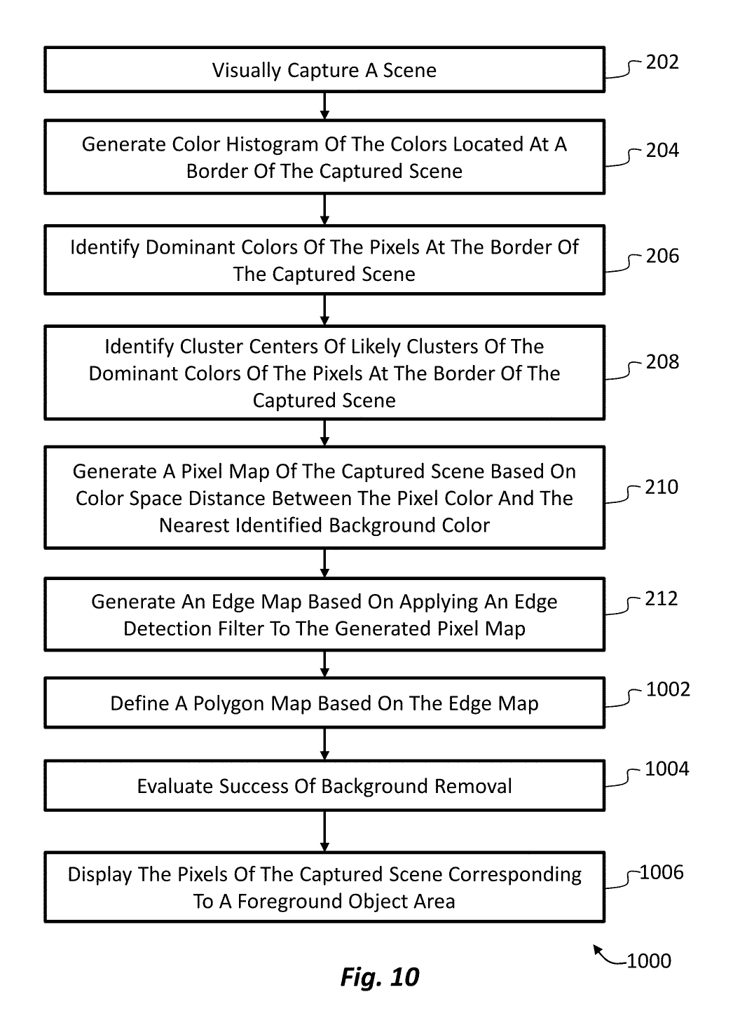

FIG. 10 is a flowchart of another example method 1000 of background removal. In some embodiments, the method 1000 may be performed by a mobile device, such as the mobile device 102 of FIG. 1. The method 1000 may include blocks 202-212, which may generally correspond to blocks 202-212 of FIG. 2.

In some embodiments, the method 1000 may continue from block 212 to block 1002 by defining a polygon map based on the edge map. In some embodiments, part or all of block 1002 may be performed by a GPU, such as the GPU 122 of FIG. 1 or a CPU, such as the CPU 121 of FIG. 1, or another processor. The polygon map may include a polygon structure that describes the bounds of the foreground object. Put another way, the polygon map may attempt to turn a collection of pixels that are identified as a likely outer edge of the foreground object into a closed polygon that accurately describes the boundary of the foreground object. Thus, for example, the polygon map may describe a foreground object area, which may include multiple discrete areas. In some embodiments, the polygon map may be generated based on available contour finding algorithms.

In some embodiments, the method 200 may continue to block 1004 by evaluating the success of the background removal. For example, the foreground object may be analyzed to determine whether the background removal resulted in a foreground object having a size within a threshold range of the captured image. For example, the foreground object may be analyzed to determine whether it fills 5% to 80% of the captured image, or some other portion of the captured image. If the relative size of the foreground object falls outside of the threshold range, the background removal may be deemed unsuccessful. Alternately or additionally, the foreground object may be analyzed to determine whether it is approximately centered relative to the captured image. If the foreground object is not centered within a threshold margin, the background removal may be deemed unsuccessful. Alternately or additionally, the foreground object may be analyzed to determine whether it appears to be visually distinct from the rest of the captured image. If the foreground object is determined not to be visually distinct form the rest of the captured image by some threshold margin, the background removal may be deemed unsuccessful. In some embodiments, determining the size and/or the center of the foreground object may be based, at least in part on a polygon map of the pixel map resulting from block 1002.

In some embodiments, the method 1000 may continue to block 1006 by displaying the foreground object. In some embodiments, part or all of block 1006 may be performed by a GPU, such as the GPU 122 of FIG. 1, and a display, such as the display 103 of FIG. 1.

Displaying the foreground object may be based on a foreground object area corresponding to the area of the polygon map defined in block 1002. Pixels of the captured scene associated with the foreground object area may be passed through to a display.

In some embodiments, pixels of the captured scene not associated with the foreground object area may not be displayed. For example, the pixels of the captured scene not associated with the foreground object may be displayed as white pixels, or some other color and/or pattern of pixels. Alternately or additionally, the pixels of the captured scene not associated with the foreground object may be replaced with pixels from another image, such as a studio blank image. Studio blank images may include high-quality images of a product background captured without a foreground object.

Optionally, a catalog shadow may be included beneath the foreground object.

In some embodiments, some or all of the blocks of the method 200 of FIG. 2 and/or the method 1000 of FIG. 10 may be repeated to provide a 15 frames-per-second (fps) preview of the background removal at a display. Alternately, the method 200 and/or the method 1000 may be repeated to provide a preview at more than 15 fps or less than 15 fps. In some embodiments, the fps of the associated preview may be based at least in part on hardware capabilities, such as processing resources available from a CPU and/or GPU of a mobile device performing the method 200 and/or the method 1000.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include tangible computer-readable storage media including random-access memory (RAM), read-only memory (ROM), electrically erasable programmable read-only memory (EEPROM), compact disc read-only memory (CD-ROM) or other optical disk storage, magnetic disk storage or other magnetic storage devices, or any other storage medium that may be used to carry or store desired program code in the form of computer-executable instructions or data structures and that may be accessed by a general-purpose or special-purpose computer. Combinations of the above may also be included within the scope of computer-readable media.

Computer-executable instructions include, for example, instructions and data which cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method of displaying a portion of a captured scene, the method comprising:
visually capturing a scene at a mobile device;
identifying an area of the captured scene associated with a foreground object of the captured scene; and
displaying, in real time at the mobile device, a displayed scene including:
a foreground portion of the captured image associated with the area identified as being associated with the foreground object of the captured scene, and
a background different from a background portion of the captured image not associated with the area identified as being associated with the foreground object of the captured scene,
wherein the displayed scene at the mobile device demonstrates an expected result of a separate background removal process.

2. The method of claim 1, wherein the displayed scene is refreshed at a rate of at least 15 frames per second (fps).

3. The method of claim 1, wherein the separate background removal process is performed by a background remover associated with an online marketplace.

4. The method of claim 1, wherein processing the captured scene includes generating a color histogram of the colors located at a border of the captured scene.

5. The method of claim 4, wherein the color histogram includes a 3-dimensional array of buckets in CIE L*a*b* (CIELAB) color space.

6. The method of claim 1, wherein processing the captured scene includes identifying dominant colors of a border of the captured scene.

7. The method of claim 6, wherein identifying the dominant colors of the captured scene includes identifying buckets of a color histogram associated with the dominant colors of the captured scene.

8. The method of claim 1, wherein processing the captured scene includes identifying cluster centers of dominant colors of a border of the captured scene.

9. The method of claim 8, wherein the cluster centers are based, at least in part, on buckets of a color histogram identified as being associated with the dominant colors of the captured scene.

10. The method of claim 1, wherein processing the captured scene includes generating a pixel map of the captured scene, each pixel of the pixel map having a color value based, at least in part, on a color space distance between a pixel color of an associated pixel of the captured scene and a cluster center of dominant colors of a border of the captured scene.

11. The method of claim 10, wherein processing the captured scene further includes generating an edge map of the pixel map.

12. The method of claim 11, wherein processing the captured scene further includes defining a polygon map based, at least in part, on the edge map.

13. The method of claim 12, wherein processing the captured scene further includes evaluating a success of a background removal based, at least in part, on the polygon map.

14. The method of claim 1, wherein displaying the displayed scene further includes displaying a catalog shadow.

15. A method of defining and displaying a foreground portion of a captured scene at a mobile device to demonstrate an expected result of a separate background removal process, the method comprising:
visually capturing a scene;
generating a color histogram of colors of pixels at a border of the captured scene;
identifying dominate colors of the pixels at the border of captured scene via the color histogram;
identifying one or more cluster centers of clusters of dominate colors of the pixels at the border of the captured scene;
generating a pixel map of the dominant colors based, a color of each of the pixels of the pixel map based, at least in part, on a color space distance between a color of an associated pixel of the captured scene and a nearest cluster center;
generating an edge map based on the pixel map;
defining a foreground area based at least in part on the edge map; and
displaying, in real time at the mobile device, a displayed scene including:
a foreground portion of the captured image associated with the area identified as being associated with the foreground of the captured scene, and
a background different from a background portion of the captured image not associated with the area identified as being associated with the foreground of the captured scene,
wherein the displayed scene at the mobile device demonstrates an expected result of a separate background removal process.

16. The method of claim 15, wherein the color histogram is performed via a CIE L*a*b* (CIELAB) color space including a 3-dimensional histogram divided into a plurality of buckets.

17. The method of claim 16, wherein identifying the dominant colors of the pixels at the border of the captured scene includes:
identifying a color associated with a largest bucket of the of the histogram;
zeroing the identified bucket; and
repeating the steps of identifying the color associated with the largest bucket and zeroing the identified bucket until the colors of a threshold portion of the pixels of the at the border of captured scene have been identified.

18. The method of claim 16, wherein identifying the dominant colors of the pixels at the border of the captured scene includes:
identifying a color associated with a largest bucket of the of the histogram;
identifying one or more colors associated with one or more buckets having a threshold value and neighboring the largest bucket;
zeroing the identified buckets; and
repeating the steps of identifying the color associated with the largest bucket and zeroing the identified bucket until the colors of a threshold portion of the pixels of the at the border of captured scene have been identified.

19. A mobile device comprising:
a display;
a camera;
a central processing unit (CPU);
a graphics processing unit (GPU); and
a non-transitory computer storage medium having computer instructions stored thereon that are executable by the CPU and GPU to perform operations comprising:
visually capturing a scene via the camera;
generating, a color histogram of colors of pixels at a border of the captured scene;
identifying dominate colors of the pixels at the border of captured scene via the color histogram;
identifying one or more cluster centers of clusters of dominate colors of the pixels at the border of the captured scene;
generating a pixel map of the dominant colors based, a color of each of the pixels of the pixel map based, at least in part, on a color space distance between a color of an associated pixel of the captured scene and a nearest cluster center;
generating an edge map based on the pixel map;
defining a foreground area based at least in part on the edge map; and
displaying, in real time at the display, a displayed scene including:
a foreground portion of the captured image associated with the area identified as being associated with the foreground of the captured scene, and
a background different from a background portion of the captured image not associated with the area identified as being associated with the foreground of the captured scene,
wherein the displayed scene at the mobile device demonstrates an expected result of a separate background removal process.

20. The mobile device of claim 19, wherein:
generating the color histogram is performed at the GPU;
identifying the dominate colors of the pixels at the border of captured scene is performed at the GPU;
identifying the one or more cluster centers is performed at the CPU;
generating the pixel map is performed at the GPU; and
generating the edge map is performed at the GPU.
